(19) United States
(12) Patent Application Publication
(10) Pub. No.: US 2026/0192622 A1
(43) Pub. Date: Jul. 9, 2026

(54) Air Spring for a Vehicle, in Particular for a Motor Vehicle, and Modular System

(71) Applicant: Bayerische Motoren Werke Aktiengesellschaft, Muenchen (DE)

(72) Inventor: Tanja BAIER, Deizisau (DE)

(21) Appl. No.: 19/127,159

(22) PCT Filed: Oct. 25, 2023
(86) PCT No.: PCT/EP2023/079810

§ 371 Date: May 5, 2025

(30) Foreign Application Priority Data
Nov. 10, 2022 (DE) 10 2022 129 748.9

(51) Int. Cl. B60G 11/27

(52) U.S. Cl. CPC B60G 11/27; B60G 2202/152; B60G 2204/423; B60G 2204/45; B60G 2206/42; B60G 2800/162

(57) ABSTRACT

An air spring for a vehicle, having a rolling piston, an air spring bellows and an outer guide, which has a lateral surface on the inner circumference for guiding the air spring bellows, wherein the outer guide has a main body on which at least one guide element is fastened in a non-destructively removable manner, which guide element forms the lateral surface on the inner circumference for guiding the air spring bellows.

### BACKGROUND AND SUMMARY

This disclosure relates to an air spring for a vehicle, in particular for a motor vehicle. The disclosure also relates to a modular system for a plurality of different design variants of an air spring for a vehicle.

A pneumatic spring for vehicles is known from FR 1 225 665 A. EP 1 424 506 B1 also discloses an air spring assembly comprising an air spring head having a receptacle for a damper bearing, which comprises an elastomer body and a support piece. A shock damper is also provided, composed of a container tube, which is at least partly surrounded by a rolling piston. In addition, an air spring bellows made of elastomeric material is provided.

An object of the present disclosure is to provide an air spring for a vehicle and to provide a modular system such that a stiffness of the air spring can be set particularly simply.

A first aspect of the disclosure relates to an air spring for a vehicle, in particular for a motor vehicle. This means that the vehicle, which is preferably in the form of a motor vehicle, particularly in the form of a car and very particularly in the form of a passenger car, comprises the air spring when the vehicle is in its completely manufactured state, the air spring very particularly being in the form of a suspension spring. In particular, this should be understood to mean that, when the vehicle is in its completely manufactured state, it can be or is supported on the ground downward in the vertical direction of the vehicle by way of the air spring, thus by way of the suspension spring. In particular, when the vehicle is in its completely manufactured state, a ground contact element of the vehicle, referred to, for example, as “vehicle wheel”, is spring-supported on a chassis of the vehicle by way of the air spring, the chassis being, for example, in the form of a superstructure, in particular in the form of a unibody. When the vehicle is in its completely manufactured state, the vehicle can be or is supported on the ground downward in the vertical direction of the vehicle by way of the ground contact element. If, for example, the vehicle is driven along the ground while the vehicle is supported on the ground downward in the vertical direction of the vehicle by way of the air spring and by way of the ground contact element, which is spring-supported on the chassis by way of the air spring, in particular connected to the chassis, for example the ground contact element rolls, in particular directly, on the ground. Unevenness of the ground, for example, results in relative movements between the ground contact element and the chassis, the relative movements running at least in the vertical direction of the vehicle in particular. A first of the relative movements can be a so-called deflection movement of the ground contact element, which moves upward in the vertical direction of the vehicle relative to the chassis during the deflection movement. In the event of the deflection movement, the air spring is compressed and thus loaded, for example. The second of the relative movements can be a so-called rebound movement of the ground contact element, which moves downward in the vertical direction of the vehicle relative to the chassis during the rebound movement. In the event of the rebound movement, the air spring is relaxed, for example. The deflection movement and the rebound movement are also collectively referred to as wheel movements or spring movements of the ground contact element.

The air spring comprises an air spring bellows, which is also referred to, simply, as “spring bellows” or “bellows” and which is made, for example, of a rubber, in particular a thread-elastomer composite. The air spring bellows is also referred to as “rolling bellows”, or the air spring bellows is in the form of a rolling bellows. The air spring additionally comprises a rolling piston, on which the air spring bellows can roll or rolls, in particular during each spring movement or wheel movement. The air spring also comprises an outer guide for guiding the air spring bellows, in particular for guiding it on the outside, the outer guide being referred to also as “outer guide device” or being in the form of an outer guide device. In particular, the rolling piston can be translationally moved, in particular along a movement direction, relative to the outer guide. For example, the air spring bellows is at least indirectly, in particular directly, connected to the rolling piston, and it is also conceivable that, for example, the air spring bellows is at least indirectly, in particular directly, connected to the outer guide. Therefore, for example a first subregion of the air spring bellows can be moved, in particular translationally, together with the rolling piston, in particular along the movement direction, relative to the outer guide and in particular relative to the second subregion of the air spring bellows. For example, the air spring bellows is connected to the rolling piston over the first subregion, in particular such that the first subregion is at least indirectly, in particular directly, connected to the rolling piston. It is also conceivable that the air spring bellows is connected to the outer guide over the second subregion, in particular such that the second subregion is at least indirectly, in particular directly, connected to the outer guide, i.e. attached to the outer guide. If for example, proceeding from an initial position of the rolling piston, a or the deflection movement of the ground contact element occurs, then for example the rolling piston and in particular, with the rolling piston, the first subregion of the air spring bellows are moved, in particular translationally, relative to the outer guide in a first direction which coincides with the movement direction or is parallel to the movement direction, such that, for example, the air spring bellows rolls on the rolling piston, in particular such that at least a first part of the air spring bellows initially spaced apart from the rolling piston, in particular from the outer circumferential lateral surface of the rolling piston, comes into contact, in particular directly, with the rolling piston, in particular with the outer circumferential lateral surface. At the same time, for example the air spring bellows also rolls on the outer guide, in particular on an inner circumferential lateral surface of the outer guide, such that, for example, at least a second part of the air spring bellows initially in contact, in particular directly, with the outer guide, in particular with the inner circumferential lateral surface of the outer guide, lifts from the outer guide, in particular from the inner circumferential lateral surface of the outer guide. In this process, for example the rolling piston and for example, with the rolling piston, the first subregion of the air spring bellows are moved from the initial position into a deflection position. If, thereupon, for example a or the rebound movement of the ground contact element occurs, the rolling piston and, with it, for example the first subregion of the air spring bellows are moved relative to the outer guide and in particular relative to the second subregion of the air spring bellows in a second direction which is opposite the first direction and coincides with the movement direction or runs parallel to the movement direction, in particular such that the rolling piston is moved from the deflection position back toward the initial position or into the initial position. In the process, for example the air spring bellows rolls on the rolling piston, in particular on the outer circumferential lateral surface of the rolling piston, such that the first part lifts from the rolling piston, in particular from the outer circumferential lateral surface of the rolling piston, and thus is again spaced apart from the rolling piston, in particular from the outer circumferential lateral surface of the rolling piston. In the process, for example the air spring bellows also rolls on the outer guide, in particular on the inner circumferential lateral surface of the outer guide, such that the second part of the air spring bellows comes into contact, in particular directly, with the outer guide, in particular with the inner circumferential lateral surface of the outer guide. Thus, the air spring bellows is guided by way of the outer guide during the wheel movements, and thus during the translational movement of the rolling piston relative to the outer guide. In other words, the inner circumferential lateral surface of the outer guide is thus provided or designed for guiding the air spring bellows. In particular, at least a length region of the rolling piston, in particular of the outer circumferential lateral surface of the rolling piston, is surrounded by the outer guide, in particular by the inner circumferential lateral surface of the outer guide, in particular all the way around, in the circumferential direction of the rolling piston. Thus, for example the air spring bellows is arranged at least partly between the rolling piston, in particular the outer circumferential lateral surface of the rolling piston, and the outer guide, in particular the inner circumferential lateral surface of the outer guide, in the radial direction of the rolling piston, the axial direction of which runs perpendicularly to the radial direction of the rolling piston. The circumferential direction runs around the axial direction of the rolling piston. For example, the axial direction of the rolling piston coincides with the movement direction. It is also conceivable that a connection of the air spring to the superstructure or a connection or attachment of the outer guide to the superstructure allows a certain Cardan system so that the rolling piston not only can move purely axially relative to the superstructure but also can perform, by contrast, at least one other movement relative to the superstructure. Thus, for example the Cardan system allows spatial movement of the rolling piston relative to the superstructure to a certain extent.

In order to then be able to set, i.e. vary, a stiffness of the air spring, also referred to as “spring stiffness” or in the form of spring stiffness, particularly simply and as required, according to the disclosure the outer guide has a main body to which at least one guide element is fastened such that nondestructive detachment is possible. The guide element forms the inner circumferential lateral surface, in particular the entire inner circumferential lateral surface, for guiding the air spring bellows. The feature according to which the guide element is held on the main body such that nondestructive detachment is possible is to be understood to mean that the guide element can be detached from the main body and then reconnected to the main body, i.e. fastened to the main body and then detached from the main body again, without damage to or destruction of the main body or the guide element. Thus, it is possible to exchange the guide element, as required, for a second guide element provided in addition to the guide element, so that selectively the first guide element or the second guide element can be fastened to the main body, in particular by way of the same fastening device provided on the main body, such that nondestructive detachment is possible. In particular, it can be provided that the second guide element differs from the first guide element. The second guide element forms, for example, a second inner circumferential lateral surface for guiding the air spring bellows, in particular completely, it being conceivable that the second inner circumferential lateral surface differs from the first inner circumferential lateral surface.

Where the guide element is mentioned below, this should be understood to mean the first guide element, unless otherwise specified. Where the inner circumferential lateral surface is mentioned below, this should be understood to mean the first inner circumferential lateral surface of the first guide element, unless otherwise specified. In particular, the inner circumferential lateral surfaces of the guide elements can differ from each other in the following way. For example, the first inner circumferential lateral surface has a first inner circumference, in particular a first inner diameter, in particular in a state in which the first guide element is fastened to the main body such that nondestructive detachment is possible. Thus, for example the first inner circumferential lateral surface is cylindrical. The second inner circumferential lateral surface has a second inner circumference, in particular a second inner diameter, for example in a state in which the second guide element is fastened to the main body instead of the first guide element such that nondestructive detachment is possible. For example, it is conceivable that the second inner circumferential lateral surface is cylindrical. It is conceivable that the first inner circumference differs from the second inner circumference, in particular that the first inner diameter differs from the second inner diameter. Thus, the inner circumferences, in particular the inner diameters, can be varied simply and as required. The disclosure is based in particular on the following findings and considerations: An important characteristic of an air spring in the form of a rolling-bellows air spring is the so-called effective area, which considerably influences the stiffness of the air spring and consequently the driving behavior of the vehicle. Typically, the effective area is established by design features. One of the design features is an outer circumference, in particular an outer diameter, of the rolling piston. A second of the design features is the inner circumference, in particular inner diameter, of the outer guide. Because the air spring according to the disclosure comprises the outer guide, the air spring according to the disclosure is in the form of an air spring having outer guidance.

In the course of a project, advantages of an expanded effective area in comparison to a volume reduction, leading to the same stiffness metrologically, were identified.

In the context of tests, it was possible to change the effective area with available test parts exclusively by way of a changed diameter of the rolling piston while keeping the diameter of the outer guide constant. Because, however, this also changes at the same time a width of a rolling fold of the air spring bellows, which is also referred to as “rolling-fold width” and extends in particular in the radial direction of the rolling piston and of the air spring as a whole, providing an air spring having a changed effective area but with unchanging rolling-fold width was identified as advantageous. In particular, the rolling fold is a fold or a region of the air spring bellows, the rolling fold or region of which is arranged between the rolling piston and the outer guide, in particular between the outer circumferential lateral surface of the rolling piston and the inner circumferential lateral surface of the outer guide, in the radial direction of the rolling piston and thus of the air spring as a whole. The disclosure then makes it possible to implement different inner circumferences, in particular inner diameters, of the outer guide, also referred to as outer-guide inner circumferences or outer-guide diameters, in combination with the same main body, the same air spring bellows and optionally the same rolling piston or different respective rolling pistons, in that selectively different guide elements, such as the aforementioned first guide element and the aforementioned second guide element, can be nondestructively fastened to the main body. For example, the different rolling pistons differ in their respective outer circumferences, in particular outer diameters. In particular, the guide element is an insert part, which is also referred to as “insert” and which, when fastened to the main body, can be located at least partly, in particular at least predominantly, and preferably completely, in the main body. The air spring according to the disclosure thus particularly advantageously can be used as a so-called tuning air spring so that, for example, different inner circumferences, in particular inner diameters, of the outer guide can be provided and tested. In the context of development of a vehicle or a plurality of vehicles, so-called tuning air springs are used to tune air springs, for example. The outer guide is typically formed by a cylindrical. deep-drawn component which is monolithic and thus formed by a single piece. It is not possible to change the outer-guide diameter or outer-guide inner circumference, or this is possible only by exchanging the entire outer guide, i.e. the entire aforementioned component. This leads to high expense, which can now be avoided by way of the disclosure. In particular, the disclosure makes it possible to vary the effective area without varying the rolling-fold width at the same time.

The use of the different rolling pistons makes it possible to keep the rolling-fold width constant when the different guide elements and thus the different outer-guide diameters are used, for example such that, for example when the first guide element is exchanged for the second guide element so that the outer-guide diameter is increased or decreased, a first of the rolling pistons is exchanged for a second of the rolling pistons, the second rolling piston having a larger or smaller outer diameter than the first rolling piston. In this way, for example the rolling-fold width can be kept constant, in particular in that the outer diameter of the second rolling piston is larger or smaller to the same extent as the outer-guide diameter is increased or decreased by the exchange of the first guide element for the second guide element.

The stiffness of a or the air spring can be influenced by the volume and also by the effective area. As tests have shown, an increase in the area in order to increase the stiffness functionally produces more advantages than a volume decrease with the same stiffness change. The effective diameter of a rolling-bellows air spring lies approximately at the center of the rolling fold. The effective area is therefore dependent both on the outer circumference, in particular outer diameter, of the rolling piston and on the inner circumference, in particular the inner diameter, of the outer guide or of the inner circumferential lateral surface of the outer guide. If, however, the outer circumference, in particular outer diameter, of the rolling piston is changed but not also the inner circumference, in particular the inner diameter, of the outer guide, in particular of the inner circumferential lateral surface, the rolling-fold width changes, the dimension of which, however, is defined specifically for the bellows in question and is relevant to service life. In addition, comfort properties and/or noise properties of the air spring are changed by a change in the rolling-fold width, so that, for example during travel of the vehicle equipped with the air spring, unfavorable effects haptically and/or acoustically perceptible to persons located in the interior of the vehicle, such as vibrations and/or noises, can occur. It has been found that the inner circumference, in particular inner diameter, of the outer guide, in particular of the inner circumferential lateral surface of the outer guide, must also be adapted or changed so that the effective area can be changed independently of the rolling-fold width, i.e. without changing the rolling-fold width. In particular in a concept and/or development phase, for example the air spring according to the disclosure can thus be used as a tuning air spring, on the basis of which an advantageous combination of outer circumference, in particular outer diameter, of the rolling piston and inner circumference, in particular inner diameter, of the outer guide can be created and tested in a simple and thus time-efficient and economical way, for example on a test bed and/or in the vehicle. One embodiment is characterized in that the guide element is secured on the main body by a retaining ring, which is fastened to the main body such that nondestructive detachment is possible, and thus the guide element is fastened to the main body such that nondestructive detachment is possible. As a result, the guide element can be mounted on and thus fastened to the main body and detached from the main body in a particularly simple and thus time-efficient and economical way, so that the stiffness of the air spring can be varied in a particularly simple, time-efficient and economical way.

In order to be able to set, i.e. vary, the inner circumference, in particular the inner diameter, of the outer guide and consequently the stiffness of the air spring particularly simply and as required, in one embodiment of the disclosure the guide element comprises at least or preferably exactly two guide parts, which form, in particularly completely, the inner circumferential lateral surface, which is also referred to as guide surface for guiding the air spring bellows. The guide parts are very preferably in the form of half-shells which form, in particular completely, the guide surface, which for example is cylindrical.

Because the inner circumferential lateral surface of the outer guide for guiding the air spring bellows is used in particular during the relative movements between the rolling piston and the outer guide, the inner circumferential lateral surface of the outer guide is also referred to as “guide surface”.

In another, particularly advantageous embodiment of the disclosure, the retaining ring is screwed, in particularly directly, to the main body and thus fastened to the main body such that nondestructive detachment is possible. In this way, the retaining ring itself can be fastened to the main body and detached from the main body again in a simple way. For example, a screwing element provided separately from the retaining ring and separately from the main body is provided, by way of which screwing element the retaining ring is screwed to the main body. In particular, the screwing element is in the form of a screw, which engages, for example, in a respective screwing opening of the retaining ring and of the main body. In particular, the screw has an external screw thread which, for example, is screwed into a corresponding internal screw thread of the main body, in particular in the screwing opening of the main body.

It has been shown to also be particularly advantageous if the retaining ring is screwed to the main body in the axial direction of the rolling piston. Thus, a screwing direction of the screwing element runs in the axial direction of the rolling piston. As a result, the retaining ring and thus the guide element can be fastened to the main body and detached from the main body in a simple way, without the entire air spring having to be removed from the rest of the vehicle for this purpose.

Another embodiment is characterized in that the guide element is screwed directly to the main body and thereby fastened to the main body such that nondestructive detachment is possible. For this purpose, for example a screwing element which is separate from the guide element and separate from the main body, such as a screw, is provided, the screwing element having, for example, an external screw thread. For example, in this embodiment the screwing element, in particular the screw, engages in corresponding screwing openings of the main body and of the guide element. For example, the screwing element is screwed by way of its external screw thread into a corresponding internal screw thread of the guide element, in particular the screwing opening of the guide element. In this way, the guide element can be connected to the main body and detached from the main body again in a way that is particularly simple and thus time-efficient and economical.

In order to be able to detach the guide element from the main body and reconnect it to the main body in a way that is particularly simple, in another embodiment of the disclosure the guide element or the screwing element is screwed directly to the main body in the radial direction of the rolling piston.

Another embodiment is characterized in that the guide element is supported directly on a stop of the main body in the axial direction of the rolling piston. In this way, precise positioning of the guide element relative to the main body can be realized in a simple way. In this case, for example the guide element is simply inserted into the main body in the axial direction of the rolling piston and thus of the outer guide until the guide element comes into support insertion, in particular direct support insertion, with the stop.

Finally, it has been found to be particularly advantageous if the stop is formed by a collar of the main body, the collar having an inner circumference. The collar has an inner side which defines the inner circumference of the collar. The guide element has an inclined portion which, considered in the radial direction of the rolling piston and thus of the outer guide toward the collar and considered in the radial direction of the rolling piston from the outside in and thus in particular to the inner side of the collar, extends obliquely to the radial direction and obliquely to the axial direction of the rolling piston toward the inner side of the collar. In this way, it is possible, for example, to avoid the situation in which the air spring bellows rolls over an excessive edge of the outer guide when the air spring bellows rolls on the outer guide, i.e. on the inner circumferential lateral surface of the outer guide, so that an excessive load on the air spring bellows can be avoided.

Alternatively or additionally, for example the guide element can be rounded and/or be in the form of a radius at the transition of the guide element to the collar so that an excessive load on the air spring bellows can be avoided.

A second aspect of the disclosure relates to a modular system for different design variants of an air spring for a vehicle. In other words, the modular system is provided for forming or producing different design variants of an air spring for a vehicle. The modular system comprises at least or exactly one rolling piston and an air spring bellows which is the same across design variants. The rolling piston can be the same across design variants, or, for the particular design variant of the air spring, a particular rolling piston is used, in which case, for example, the rolling pistons can differ from each other in their respective outer circumferences, in particular outer diameters. The modular system also comprises an outer guide, which has a main body which is the same across design variants and at least one design-variant-specific first guide element, which has a design-variant-specific first inner circumferential lateral surface for guiding the air spring bellows. The outer guide also has at least one design-variant-specific second guide element which is different from the first guide element and which has a design-variant-specific second inner circumferential lateral surface for guiding the air spring bellows. To form the design variants, selectively the first guide element or the second guide element can be fastened to the main body, in particular by way of the same fastening device of the main body, such that nondestructive detachment is possible. Advantages and advantageous embodiments of the first aspect of the disclosure are to be regarded as advantages and advantageous embodiments of the second aspect of the disclosure, and vice versa.

In particular, the first guide element and the second guide element differ in an inner circumference, in particular inner diameter, of the inner circumferential lateral surface. Thus, for example the first inner circumferential lateral surface has a first inner circumference, in particular a first inner diameter. In particular, it is conceivable that the first inner circumferential lateral surface is cylindrical and thus has the form of a straight circular cylinder, which in particular is in the form of a hollow cylinder. For example, the second inner circumferential lateral surface has a second inner circumference, in particular a second inner diameter, for example the second inner circumferential lateral surface being cylindrical and thus having the form of a straight circular cylinder, which in particular is in the form of a hollow cylinder. For example, the second inner circumference, in particular the second inner diameter, is larger or smaller than the first inner circumference, in particular than the first inner diameter. As a result, the stiffness of the air spring can be varied in a particularly simple way.

### BRIEF DESCRIPTION OF THE DRAWINGS

Additional details of the disclosure are clear from the following description of preferred exemplary embodiments with the associated drawings.

FIG. 1 shows a portion of a schematic longitudinal sectional view of an air spring for a vehicle;

FIG. 2 shows a schematic longitudinal sectional view of an outer guide of the air spring;

FIG. 3 shows a schematic and perspective exploded view of the air spring;

FIG. 4 shows a schematic longitudinal sectional view of a main body of the outer guide;

FIG. 5 shows a schematic bottom view of the main body;

FIG. 6 shows a schematic top view and a schematic sectional view of a retaining ring of the air spring;

FIG. 7 shows a schematic longitudinal sectional view of a first guide element;

FIG. 8 shows a schematic longitudinal sectional view of a second guide element of the air spring;

FIG. 9 shows a schematic longitudinal sectional view of a third guide element of the air spring; and,

FIG. 10 shows a schematic longitudinal sectional view of a fourth guide element of the air spring.

In the figures, identical or functionally identical elements are provided with identical reference signs.

### DETAILED DESCRIPTION OF THE DRAWINGS

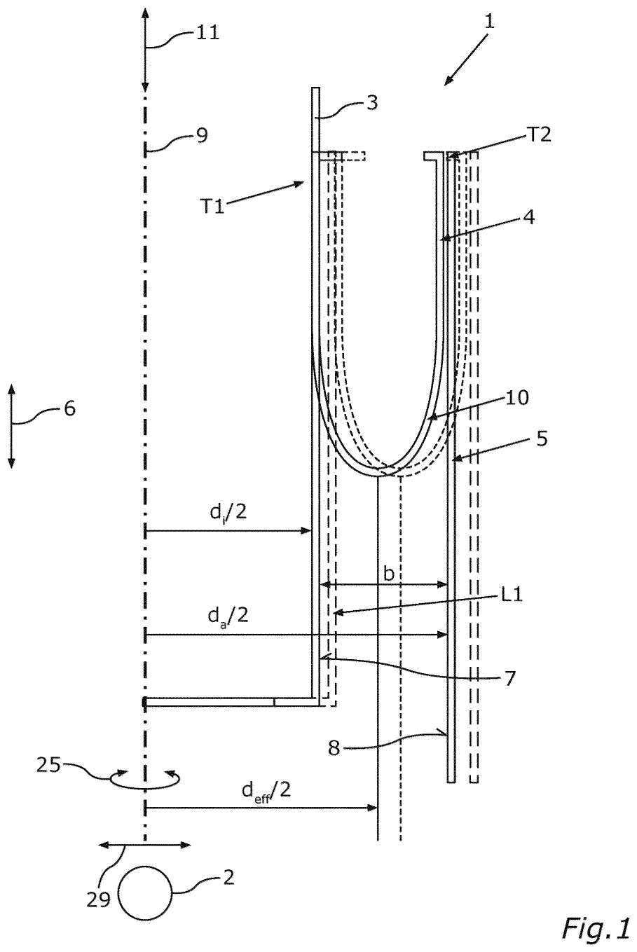

FIG. 1 shows, in a schematic longitudinal sectional view, an air spring 1 for a vehicle which is preferably in the form of a motor vehicle, particularly in the form of a car. The vehicle has ground contact elements which, for example, are in the form of vehicle wheels. The vehicle also has a chassis which, for example, is in the form of a superstructure, particularly in the form of a unibody. One of the ground contact elements which, in the present case, are in the form of vehicle wheels is spring-supported on the chassis by way of the air spring 1. The vehicle wheel spring-supported on the chassis by way of the air spring 1 is shown particularly schematically in FIG. 1 and is denoted by 2.

The air spring 1 has a rolling piston 3, an air spring bellows 4 also referred to as “bellows” or “spring bellows”, and an outer guide 5 for guiding the air spring bellows 4. The air spring bellows 4 is also referred to as “rolling bellows” or is a rolling bellows. The air spring bellows 4 is fastened to the rolling piston 3, in particular over a first subregion T1 of the air spring bellows 4. The air spring bellows 4 is also fastened to the outer guide 5, in particular over a second subregion T2 of the air spring bellows 4. In particular, the outer guide 5 is at least indirectly, in particular directly, fastened to the chassis such that the outer guide is stationary relative to the chassis. The rolling piston 3 and thus for example, with the rolling piston 3, the subregion T1 can be translationally moved along a movement direction illustrated by a double arrow 6 in FIG. 1, relative to the outer guide 5, relative to the chassis and thus for example also relative to the subregion T2 of the air spring bellows 4. Such translational relative movements between the rolling piston 3 and the outer guide 5 along the movement direction (double arrow 6) occur, for example, in the event of deflection and rebound movements of the vehicle wheel 2, which are collectively also referred to as “wheel movement”. In the translational relative movements between the rolling piston and the outer guide 5 along the movement direction, the air spring bellows 4 rolls on the rolling piston 3, in particular on an outer circumferential lateral surface 7 of the rolling piston 3, and on the outer guide 5, in particular on an inner circumferential lateral surface 8 of the outer guide 5, wherein the air spring bellows 4 is to be guided, or is or becomes guided, by way of the inner circumferential lateral surface 8. The outer circumferential lateral surface 7 is cylindrical and thus has the shape of a straight circular cylinder. The inner circumferential lateral surface 8 is cylindrical and thus has the shape of a straight circular cylinder, which is in the form of a hollow cylinder. It can be seen that the rolling piston 3 and the outer guide 5 are arranged one inside the other at least partly, such that at least a length region L1 of the rolling piston 3 is arranged in the outer guide 5. This is possible in at least one position of the rolling piston 3. In this case, at least the length region L1 is completely peripherally surrounded by the outer guide 5, in particular by the inner circumferential lateral surface 8, in the circumferential direction of the rolling piston 3, the axial direction of which is denoted by 9 in FIG. 1, the length region L1 of the rolling piston 3 being a length region L1 of the outer circumferential lateral surface 7. For example, the subregion T2 is fastened to the outer guide 5 by way of a clamp fit. It is clear from FIG. 1 that the air spring bellows 4 is arranged at least partly between the rolling piston 3 and the outer guide 5, i.e. between the lateral surfaces 7 and 8, in the radial direction of the rolling piston 3 and thus of the air spring 1 as a whole. The air spring bellows has a rolling fold 10, which is also simply referred to as “fold” and which is arranged between the rolling piston 3 and the outer guide 5, i.e. between the lateral surfaces 7 and 8, in the radial direction of the rolling piston 3 and thus of the air spring 1 as a whole. The axial direction of the rolling piston 3 and thus of the air spring 1 as a whole is illustrated by a double arrow 11, and the radial direction of the rolling piston 3 and thus of the air spring 1 as a whole is illustrated by a double arrow 29 and runs perpendicularly to the axial direction. In FIG. 1, di denotes a diameter, in particular outer diameter, of the rolling piston 3, in particular of the lateral surface 7, the diameter also being referred to as “rolling-piston diameter”. In FIG. 1, da denotes an inner diameter of the outer guide 5, in particular of the lateral surface 8, the inner diameter also being referred to as “outer-guide diameter”. In FIG. 1, deff denotes an effective diameter of the air spring 1, and b denotes a width of the rolling fold 10, the width running in the radial direction of the rolling piston 3 and thus of the outer guide 5 and of the air spring 1 as a whole and also being referred to as “rolling-fold width”. The so-called effective area of the air spring 1 results, for example, from the following formula:

$${A = π ( {d}_{eff} / 2 ]}^{2} .$$

The symbol A denotes the effective area of the air spring 1.

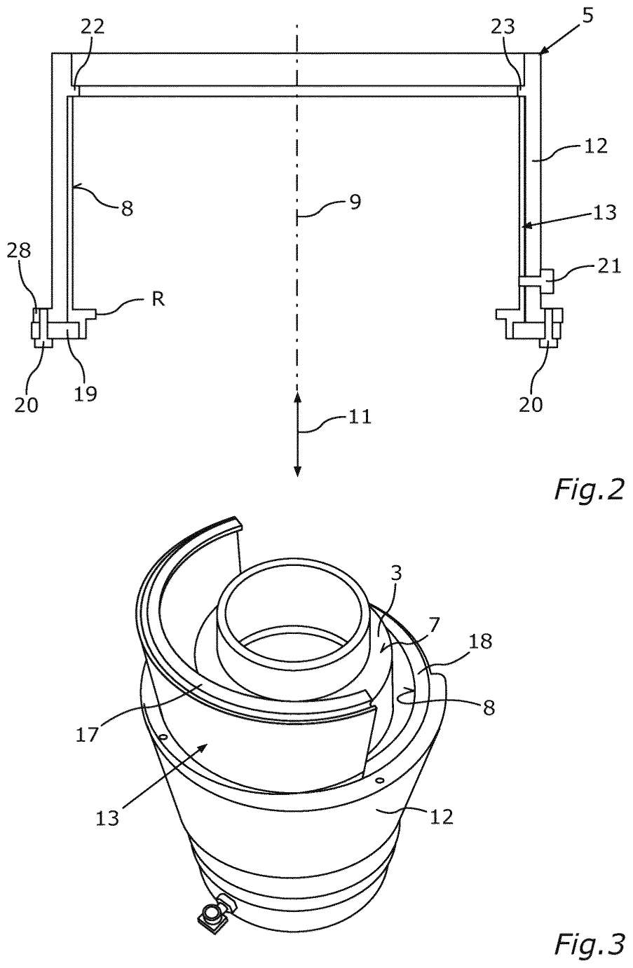

In FIG. 1, different rolling-piston diameters, different outer-guide diameters and different rolling-fold widths are illustrated by dashed lines. For example by varying the effective area, a stiffness of the air spring 1 can be varied, i.e. set. In order then to be able to set, i.e. vary, the stiffness of the air spring particularly simply and as required, the outer guide 5 has a main body 12, as can be seen in combination with FIG. 2, the main body being made of a metal material, for example. The metal material is, for example, a light metal, in particular aluminum. The main body 12 is preferably monolithic, and therefore formed by a single piece. The outer guide 5 also has at least one guide element 13, which is separate from the main body 12 and is fastened to the main body 12 such that nondestructive detachment is possible. The guide element 13 forms the inner circumferential lateral surface 8 for guiding the air spring bellows 4, in particular forms the entirety of the inner circumferential lateral surface.

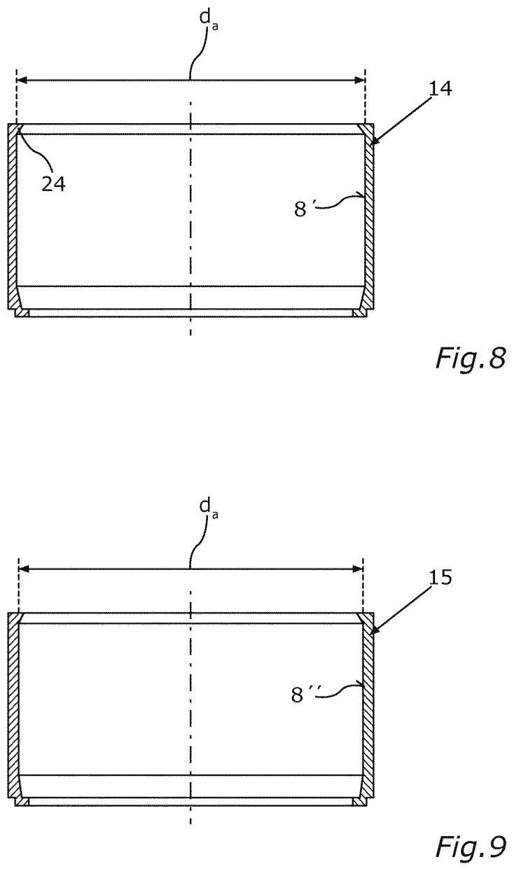

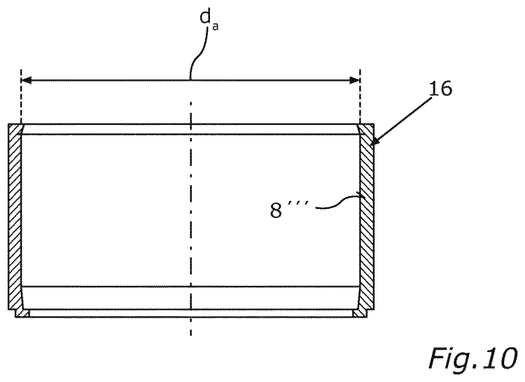

In particular, a modular system is provided which comprises the rolling piston 3 which is preferably the same across design variants, the air spring bellows 4 which is the same across design variants, and the main body 12 which is the same across design variants, and the design-variant-specific guide element 13 as first guide element and also further guide elements which are clear from FIGS. 8 to 12, namely a design-variant-specific second guide element 14, a design-variant-specific third guide element 15, and a design-variant-specific fourth guide element 16. The guide elements 13, 14, 15 and 16 can be selectively fastened to the main body 12, preferably by way of the same fastening device of the main body 12. It is clear that each guide element 14, 15, 16 likewise has an inner circumferential lateral surface 8′, 8″, 8″′ for guiding the air bellows 4. The inner circumferential lateral surfaces 8, 8′, 8″, 8″′ differ in their outer-guide diameters, in particular such that the outer-guide diameter of the lateral surface 8′ is larger than that of the lateral surface 8, the outer-guide diameter of the lateral surface 8″ is larger than that of the lateral surface 8 and smaller than that of the lateral surface 8′, and for example the outer-guide diameter of the lateral surface 8″′ is smaller than that of the lateral surface 8″ and larger than that of the lateral surface 8.

The preceding and following statements regarding the guide element 13 can also be readily applied to the other guide elements 14, 15 and 16, and vice versa. From FIG. 3, an example of the guide element 13 is clear which shows that each guide element 13, 14, 15, 16 preferably comprises exactly two guide parts 17 and 18 which are in the form of half-shells and which completely form the lateral surface 8 when the guide element 13 is fastened to the main body 12. The preceding and following statements regarding the lateral surface 8 can also be readily applied to the lateral surfaces 8′, 8″ or 8″′, and vice versa. Each guide part 17, 18 is preferably made of a plastic. It is clear from FIGS. 2 and 3 that the guide element 13 and thus the guide parts 17 and 18 are at least partly arranged in the main body, such that the guide parts 17 and 18 or the guide element 13 is in the form of an insert part, which is also referred to as “insert”. In summary, the insert parts (guide elements 13, 14, 15 and 16) thus have different. inner diameters and thus different outer-guide diameters. In the first exemplary embodiment shown in FIG. 2, a retaining ring 19 separate from the guide element 13 and separate from the main body 12 and also separate from the rolling piston 3 can be provided, by way of which retaining ring the guide element 13 is secured on the main body 12 such that nondestructive detachment is possible and thus is retained on the main body 12 such that nondestructive detachment is possible. For this purpose, the retaining ring 19 is screwed, in particular directly, to the main body 12 and thereby fastened to the main body 12 such that nondestructive detachment is possible. For this purpose, a plurality of screwing elements 20 in the form of screws are provided, each screwing element 20 penetrating a corresponding screwing opening of the retaining ring 19 in the form of a through-opening and engaging in a corresponding screwing opening of the main body 12 in the form of, for example, a through-opening or a blind hole. In the screwing opening of the main body 12, for example a first screw thread, in particular a first internal screw thread, is arranged, the screwing element 20 having, for example, a second screw thread corresponding to the first screw thread. In this case, the second screw thread is screwed, in particular directly, into the first screw thread, whereby the retaining ring 19 is screwed onto the main body 12. In the axial direction 9 of the rolling piston 3 and thus of the outer guide 5, the guide element 13 is supported on one side, in particular at one end, on a stop 22 of the main body 12, in particular directly. On the other side, in particular at the other end, in the axial direction 9 of the rolling piston 3 and thus of the outer guide 5, the guide element 13 is supported on the retaining ring 19, in particular directly. As a result, the guide element 13 is secured on the main body 12. It is clear from FIG. 2 that, in the first exemplary embodiment, the retaining ring 19 is screwed to the main body 12 in the axial direction 9 of the rolling piston 3 and thus of the outer guide 5.

In a second exemplary embodiment shown in FIG. 2, the guide element 13 is screwed directly to the main body 12. For this purpose, at least one screwing element 21 is provided, which, for example, is in the form of a screw and which engages in corresponding screwing openings of the main body 12 and of the guide element 13, in particular such that the screwing element 21 penetrates the corresponding screwing opening of the main body 12, the screwing opening being in the form of a through-opening, and engages in the corresponding screwing opening of the guide element 13, the screwing opening being in the form of, for example, a through-opening. In the screwing opening of the guide element 13, for example a third screw thread, in particular an internal screw thread, is arranged. The screwing element 21 has, for example, a fourth screw thread, in particular external screw thread, corresponding to the third screw thread. In particular, the fourth screw thread is screwed directly into the third screw thread. As a result, the guide element 13 is fastened to the main body 12 such that nondestructive detachment is possible. It is clear from FIG. 2 that the guide element 13 or the screwing element 21 is screwed to the main body 12 in the radial direction.

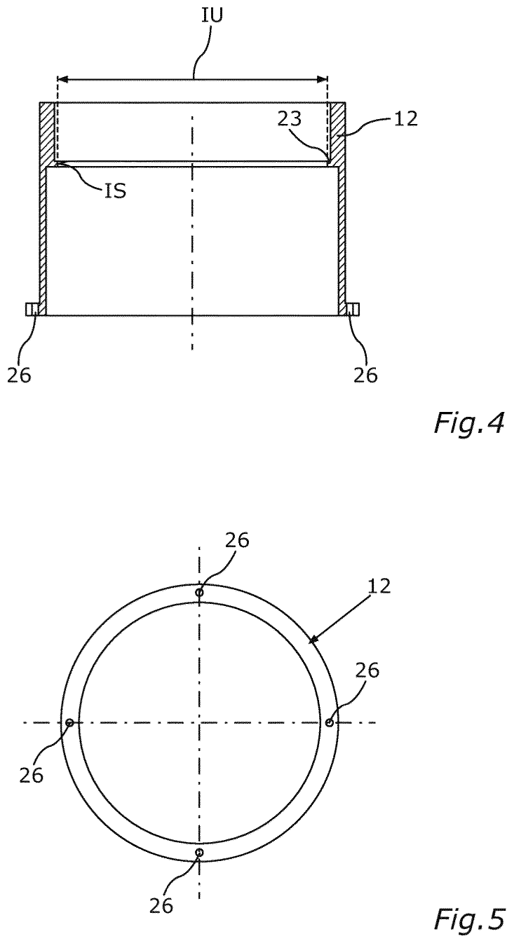

The stop 22 of the main body 12 is formed by a collar 23 of the main body 12. The collar 23 has an inner circumference IU which is clear from FIG. 4 and which is formed by an inner side IS of the collar 23. If, for example, the outer-guide diameter is larger than the inner diameter IU, which is the case, for example, for the guide elements 14, 15 and 16, the guide element 14, 15, 16 has an inclined portion 24 which, in particular, extends all the way around in the circumferential direction of the rolling piston 3. The circumferential direction of the rolling piston 3 and thus of the air spring 1 as a whole is illustrated by a double arrow 25 in FIG. 1. It is clear from, for example, FIG. 8 that the inclined portion 24, considered in the axial direction 9 of the rolling piston 3 and thus of the air spring 1 as a whole toward the collar 23 and considered in the radial direction of the rolling piston 3 from the outside in, extends obliquely to the radial direction and obliquely to the axial direction of the rolling piston 3 toward the inner side IS. If, for example, the air spring bellows 4 then rolls on the lateral surface 8′, 8″, 8″′, and thus on the outer guide 5, the particular guide element 14, 15, 16 and the collar 23 do not form an excessive edge over which or on which the air spring bellows 4 rolls. As a result, an excessive load on the air spring bellows 4 can be avoided. The multi-part design of the guide element 13, 14, 15, 16, in particular such that the guide element 13, 14, 15, 16 comprises the at least or exactly two guide parts 17 and 18 which are preferably in the form of half-shells, is advantageous insofar as the guide elements 13, 14, 15 and 16 having the different outer-guide diameters thus can be exchanged for each other and therefore can be selectively fastened to the main body 12, namely directly on the vehicle, i.e. without having to remove the air spring 1. For example, an air spring internal pressure present in particular in the air spring bellows 4 is merely released, whereupon the guide elements are exchanged. Then, for example, the air spring 1 is refilled with air.

For example, the retaining ring 19, also referred to simply as “ring”, is made of a plastic. It is conceivable that each screwing element 20 and/or 21 is in the form of a square socket screw, in particular a hexagon socket screw. It is clear from FIG. 2 that, in the first exemplary embodiment, the retaining ring 19 is screwed against a corresponding flange 28 of the main body 12 by way of each screwing element 20, so that in the present case the screwing opening of the main body 12 is formed in the flange 28. It is clear that, by selectively fastening the guide elements 13, 14, 15 and 16 to the main body 12, a changeable outer guide and thus a changeable outer-guide diameter of the outer guide 5 can be implemented.

Proceeding from a conventional air spring, for example a part of the conventional outer guide 5 near an upper bellows seat can be removed, so that, for example, only an outer guide ring remains. Then, for example, a main body part, in particular a turned main body part and very particularly a turned aluminum main body part, can be arranged on, in particular placed onto, the outer guide ring and connected, in particular glued and/or welded, to the outer guide ring, so that, for example, the outer guide ring and the main body part form the main body 12. In contrast, it is conceivable that the main body 12 is in the form of a monolithic main body and thus in the form of a monoblock, so that preferably the main body 12 is formed by a single piece and thus is not composed of a plurality of parts which are separate from each other and connected to each other. For example at the lower flange 28, the guide parts 17 and 18 are matched to the retaining ring 19 and in particular provided with a rim R protruding inward in the radial direction. In particular, for example the rim R projects inward in the radial direction of the outer guide 5 from the lateral surface 8 or from a region of the guide element 13 adjoining the rim R. By way of the rim R, the guide element 13 can be removed particularly simply, since for example a person can pull on it by hand and thus can exert a force in the axial direction on the guide element 13. In the second exemplary embodiment, the flange 28 can be omitted, because the guide element 13 is screwed directly to the main body 12.

FIG. 5 shows the main body 12 in a schematic bottom view. FIGS. 4 and 5 show the screwing openings of the main body 12 which are denoted by 26, in the screwing openings 26 of which main body the respective screwing elements 20 are or become screwed.

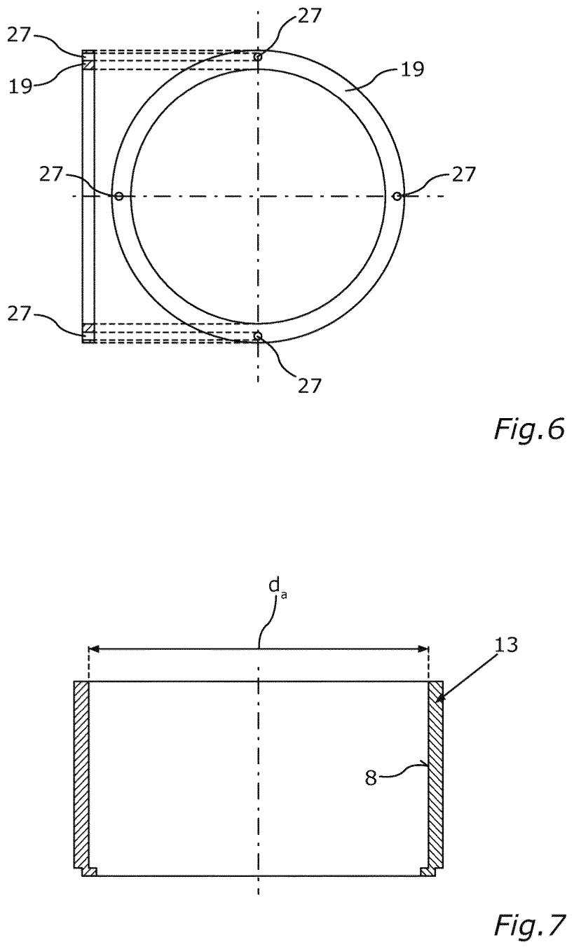

FIG. 6 shows a schematic top view and a schematic longitudinal sectional view of the retaining ring 19, the screwing openings of which are denoted by 27.

### LIST OF REFERENCE SIGNS

1 Air spring
2 Vehicle wheel
3 Rolling piston
4 Air spring bellows
5 Outer guide
6 Double arrow
7 Outer circumferential lateral surface
8 Inner circumferential lateral surface
9 Axial direction
10 Rolling fold
11 Double arrow
12 Main body
13 Guide element
14 Guide element
15 Guide element
16 Guide element
17 Guide part
18 Guide part
19 Retaining ring
20 Screwing element
21 Screwing element
22 Stop
23 Collar
24 Inner side
25 Double arrow
26 Screwing opening
27 Screwing opening
28 Flange
29 Double arrow
T1 First subregion
T2 Second subregion
L1 Length region
R Rim
IU Inner circumference
IS Inner side
Di Outer diameter
Da Inner diameter
D_{eff} Diameter
b Width

1.-10. (canceled)

11. An air spring for a vehicle, comprising:
a rolling piston,
an air spring bellows, and
an outer guide, which has an inner circumferential lateral surface for guiding the air spring bellows,
wherein the outer guide has a main body, to which at least one guide element is fastened such that nondestructive detachment is possible, the guide element forming the inner circumferential lateral surface for guiding the air spring bellows.

12. The air spring according to claim 11, wherein the guide element comprises at least or exactly two guide parts, which form the inner circumferential lateral surface.

13. The air spring according to claim 11, wherein the guide element is made of a plastic.

14. The air spring according to claim 11, wherein the guide element is secured on the main body by a retaining ring, which is fastened to the main body such that nondestructive detachment is possible, and thus the guide element is fastened to the main body such that nondestructive detachment is possible.

15. The air spring according to claim 14, wherein the retaining ring is screwed to the main body and thus is fastened to the main body such that nondestructive detachment is possible.

16. The air spring according to claim 15, wherein the retaining ring is screwed to the main body in the axial direction of the rolling piston.

17. The air spring according to claim 11, wherein the guide element is screwed directly to the main body and thus fastened to the main body such that nondestructive detachment is possible.

18. The air spring according to claim 11, wherein the guide element is supported directly on a stop of the main body in the axial direction of the rolling piston.

19. The air spring according to claim 18, wherein the stop is formed by a collar of the main body, the collar having an inner circumference, and the collar of the main body having an inner side which defines the inner circumference of the collar, wherein the guide element has an inclined portion which, considered in the axial direction of the rolling piston toward the collar and considered in the radial direction of the rolling piston from the outside in, extends obliquely to the radial direction and obliquely to the axial direction of the rolling piston toward the inner side of the collar.

20. A modular system for different design variants of an air spring for a vehicle, comprising:
a rolling piston;
an air spring bellows which is the same across design variants; and
an outer guide comprising:
a main body which is the same across design variants;
at least one design-variant-specific first guide element, which has a design-variant-specific first inner circumferential lateral surface for guiding the air spring bellows; and
at least one design-variant-specific second guide element which is different from the first guide element and which has a design-variant-specific second inner circumferential lateral surface for guiding the air spring bellows, wherein, to form the design variants, selectively the first guide element or the second guide element can be fastened to the main body such that nondestructive detachment is possible.
